(19) United States
(12) Patent Application Publication
(10) Pub. No.: US 2022/0120249 A1
(43) Pub. Date: Apr. 21, 2022

(54) Fuel Injection Device and Control Device

(71) Applicant: Hitachi Astemo, Ltd., Hitachinaka-shi, Ibaraki (JP)

(72) Inventors: Ryo KUSAKABE, Tokyo (JP); Yoshihiro SUKEGAWA, Tokyo (JP); Masayuki SARUWATARI, Hitachinaka-shi, Ibaraki (JP)

(21) Appl. No.: 17/418,955

(22) PCT Filed: Feb. 7, 2020
(86) PCT No.: PCT/JP2020/004724

§ 371 Date: Jun. 28, 2021

(30) Foreign Application Priority Data
Feb. 8, 2019 (JP) 2019-021460

(51) Int. Cl. F02M 61/18; F02D 41/40

(52) U.S. Cl. CPC F02M 61/1806; F02D 41/401

(57) ABSTRACT

An object of the present invention is to enable forming of fuel sprays capable of suppressing discharge of PN, HC, and the like. Thus, in a fuel injection device 100 having a plurality of injection holes, the fuel injection device includes a first injection hole group 801 that is directed in a direction on an exhaust valve 211 side with respect to an intake valve 205 side, and a second injection hole group 802 that is directed in a direction on the intake valve 205 side with respect to the exhaust valve 211 side. A flow rate of the second injection hole group 802 is larger than a flow rate of the first injection hole group 801.

### TECHNICAL FIELD

The present invention relates to, for example, a fuel injection device used in an internal combustion engine and a control device thereof.

### BACKGROUND ART

For example, WO 2013/008692 A (PTL 1) describes a fuel injection valve having a large-diameter injection hole that injects fuel into an annular space including a region with a strong tumble flow and a small-diameter injection hole that injects fuel into a space including a region with a weak tumble flow (see ABSTRACT). This fuel injection valve reduces dilution of oil and reduces fuel adhesion or the like to a cylinder liner and a piston crown surface by reducing penetration of sprays directed to the cylinder liner and the piston crown surface and maintains an injection amount as a whole and appropriately controls combustion efficiency by directing the sprays of the increased penetration in a region with high fluidity (see paragraph 0015).

### CITATION LIST

### Patent Literature

PTL 1: WO 2013/008692 A

### SUMMARY OF INVENTION

### Technical Problem

In a fuel injection device of an internal combustion engine, in order to achieve low exhaust, a method for encouraging mixing of fuel and air to suppress unburned gas by increasing a system fuel pressure and atomizing particles of the injected fuel and a method for reducing unburned particles by suppressing the adhesion of the fuel sprays to an inside of an engine cylinder have been implemented.

Especially when a fuel pressure is increased for atomization, since a penetration force of the fuel sprays increases, the injected fuel sprays adhere to an intake valve and a cylinder inner wall surface, and the amount of discharged substances such as PN and HC may increase.

For example, as in the method of PTL 1, in a fuel injection device having a plurality of injection holes, it is possible to reduce an adverse effect due to a penetration increase by decreasing a diameter of an injection hole that injects fuel into a region in which an air flow is small and increasing a diameter of an injection hole that injects fuel into a region in which an air flow is large.

However, when the diameter of the injection hole that injects the fuel into the region in which the air flow is large is increased, an air-fuel mixture flows by a strong air flow, and thus, a reaching distance of the sprays is extended. Accordingly, the fuel adhesion to the piston may increase.

For the above reasons, in the method of PTL 1, it cannot be said that sufficient consideration is necessarily given to means for reducing the piston adhesion for reducing PN and HC.

An object of the present invention is to enable forming of fuel sprays capable of suppressing discharge of PN, HC, and the like.

### Solution to Problem

In order to achieve the object, a fuel injection device of the present invention is a fuel injection device having a plurality of injection holes, and the fuel injection device includes a first injection hole group that is directed in a direction on an exhaust valve side with respect to an intake valve side, and a second injection hole group that is directed in a direction on the intake valve side with respect to the exhaust valve side. A flow rate of the second injection hole group is larger than a flow rate of the first injection hole group.

In order to achieve the object, a fuel injection device of the present invention is a fuel injection device having a plurality of injection holes, and the fuel injection device includes a first injection hole group that is directed in a direction on an exhaust valve side with respect to an intake valve side, and a second injection hole group that is directed in a direction on the intake valve side with respect to the exhaust valve side. a total cross-sectional area of injection hole outlet surfaces of the second injection hole group is larger than a total cross-sectional area of injection hole outlet surfaces of the first injection hole group.

In order to achieve the object, a fuel injection device of the present invention is a fuel injection device having a plurality of injection holes, and a total cross-sectional area of injection holes that inject fuel in a direction along a flow direction of gas directed to an exhaust valve opening surface side from an intake valve opening surface side is smaller than a total cross-sectional area of injection holes that inject fuel in a direction facing the flow direction.

### Advantageous Effects of Invention

According to the present invention, it is possible to reduce the adhesion of the sprays to the cylinder inner wall surface, and it is possible to suppress the discharge of PN and HC. Other objects, configurations, and effects will be made apparent in the following descriptions.

### BRIEF DESCRIPTION OF DRAWINGS

FIG. 1 is a diagram showing a fuel injection system including a fuel injection device 100 and a drive device 150 according to an embodiment of the present invention, and is a diagram showing the fuel injection device 100 in a cross section parallel to a center axis 100a.

FIG. 2 is a schematic diagram of an in-cylinder direct injection type internal combustion engine (direct injection engine) in which fuel is directly injected into a cylinder inside and which is equipped with the fuel injection device 100 according to the embodiment of the present invention.

FIG. 3 is a schematic diagram showing a form of fuel sprays injected into a cylinder inside (inside the cylinder 210) of FIG. 2.

FIG. 4 is a projection view of the fuel sprays injected from the fuel injection device 100 when FIG. 3 is viewed in a direction of a piston 214 from the fuel injection device 100 side.

FIG. 5 is a projection view of the fuel sprays injected from the fuel injection device 100 when FIG. 3 is viewed in the direction of the fuel injection device 100 from the piston 214 side.

FIG. 6 is an enlarged view of an orifice 116 viewed from a distal end direction of the fuel injection device 100 according to a first embodiment of the present invention.

FIG. 7 is a cross-sectional view of a cross section B-B′ in FIG. 6.

FIG. 8 is a diagram showing a change example in which a shape of an injection hole of the fuel injection device 100 according to the first embodiment of the present invention is changed.

FIG. 9 is a diagram showing an injection method executed by a control device 154 according to the first embodiment of the present invention.

FIG. 10 is a diagram showing a relationship between a flow rate ratio of a first injection hole group 801 and a second injection hole group 802 and PN according to the embodiment of the present invention.

FIG. 11 is a diagram showing an injection method executed by a control device 154 according to a second embodiment of the present invention.

FIG. 12 is a projection view of fuel sprays injected from a fuel injection device 100′ when viewed in the direction of the fuel injection device 100 from a piston 209 side in FIG. 2, in another example of the fuel injection device 100 (fuel injection device 100′).

FIG. 13 is an enlarged view of an orifice 116′ viewed from a distal end direction of the fuel injection device 100′ of FIG. 12.

### DESCRIPTION OF EMBODIMENTS

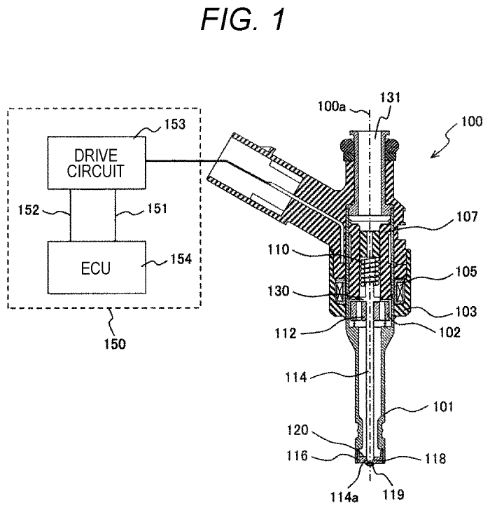

Hereinafter, an operation and a configuration of a fuel injection device according to an embodiment of the present invention will be described with reference to FIGS. 1 to 14. In the following description, the same reference signs are assigned to configurations common in the drawings or embodiments, and the description thereof will be omitted for each drawing or embodiment. Even though the configurations have the same reference signs, whenever there is a particular need for description, the description will be given.

### First Embodiment

A configuration and an operation of a fuel injection device according to a first embodiment of the present invention will be described with reference to FIG. 1. FIG. 1 is a diagram showing a fuel injection system including a fuel injection device 100 and a drive device 150 according to an embodiment of the present invention, and is a diagram showing the fuel injection device 100 in a cross section parallel to a center axis 100a.

In the present specification and the claims, although an up-down direction may be designated, this up-down direction is based on an up-down direction of FIG. 1, and does not necessarily match an up-down direction in a mounted state of the fuel injection device 100. In a direction along the center axis 100a, a side of the fuel injection device 100 on which injection holes 119 are provided is a distal end side, and an opposite side (a side on which fuel is supplied) is a base end side.

Fuel injection of the fuel injection device 100 is controlled by a width of an injection pulse sent from an engine control unit (ECU) 154. This injection pulse is input to a drive circuit 153 of the fuel injection device 100, and the drive circuit 153 decides a drive current waveform based on an instruction from the ECU 154 and supplies a drive current to the fuel injection device 100 by a time based on the injection pulse. The drive circuit 153 may be mounted as a component or a board integrated with the ECU 154. A device in which the drive circuit 154 and the ECU 154 are integrated is called the drive device 150. The ECU 154 and the drive device 150 including the ECU 154 may be called a control device.

Next, a configuration and a basic operation of the fuel injection device 100 and the drive device 150 will be described.

The ECU 154 receives signals indicating states of an engine from various sensors, and calculates a width of an injection pulse and an injection timing for controlling an injection amount to be injected from the fuel injection device 100 according to an operating condition of an internal combustion engine. The ECU 154 includes an A/D converter and an I/O port for receiving signals from various sensors. The injection pulse output from the ECU 154 is input to the drive circuit 153 of the fuel injection device through a signal line 151. The drive circuit 153 controls a voltage applied to a solenoid 105 and supplies a current to the solenoid 105. The ECU 154 communicates with the drive circuit 153 through a communication line 152, and can switch between drive currents generated by the drive circuit 153 according to a pressure of the fuel supplied to the fuel injection device 100 and the operating condition, and change set values of a current and a current supply time.

Next, a configuration and an operation of the fuel injection device 100 will be described. The fuel injection device 100 in FIG. 1 is a normally closed valve type electromagnetic fuel injection device. In a state in which the coil 105 is not energized, a valve body 114 is urged in a valve closing direction by a spring 110, and comes in close contact with the valve seat 118 and is in a closed state. In this closed state, a mover (movable core) 102 is brought into close contact with the valve body 114 by a zero spring 112, and has a void between the mover 102 and a magnetic core (fixed core) 107 in a state in which the valve body 114 is closed. The fuel is supplied from an upper part of the fuel injection device 100, and the fuel is sealed by the valve seat 118. When the valve is closed, a force due to the spring 110 and a force due to the fuel pressure act on the valve body 114, and the valve body 114 is pushed in a closing direction (valve closing direction). A magnetic circuit that generates an electromagnetic force for opening or closing a valve includes a nozzle holder 101 which is a cylindrical member disposed on an outer peripheral side of the magnetic core 107 and the mover 102, the magnetic core 107, the mover 102, and a housing 103. When a current is supplied to the coil 105, a magnetic flux is generated in the magnetic circuit, and a magnetic attraction force is generated between the mover 102 which is a movable component and the magnetic core 107. When the magnetic attraction force acting on the mover 102 exceeds the sum of a load by the spring 110 and the force acting on the valve body 114 due to the fuel pressure, the mover 102 moves upward. At this time, the valve body 114 moves upward together with the mover 102, and moves to a position at which an upper end surface of the mover 102 collides with a lower end surface of the magnetic core 107. As a result, the valve body 114 is separated from the valve seat 118, and the supplied fuel is injected from the plurality of injection holes 119.

Next, after the upper end surface of the mover 102 collides with the lower end surface of the magnetic core 107, the valve body 114 is separated from the mover 102 and overshoots, but is pushed back by the spring 110 and stands still on the mover 102. When the supply of the current to the coil 105 is cut off, the magnetic flux generated in the magnetic circuit decreases, and the magnetic attraction force is reduced. When the magnetic attraction force becomes smaller than the combined force of the load by the spring 110 and a fluid force received by the valve body 114 and the mover 102 due to the fuel pressure, the mover 102 and the valve body 114 move downward, and the mover 102 is separated from the valve body 114 at a point in time when the valve body 114 collides with the valve seat 118. On the other hand, the valve body 114 stands still after colliding with the valve seat 118, and the injection of the fuel is stopped. The mover 102 and the valve body 114 may be integrally molded as the same member, or may be formed as separate members and coupled by a method such as welding or press-fitting. A cylindrical orifice 116 having the plurality of injection holes 119 is coupled to the nozzle holder 101, and the orifice 116 has a guide portion 120 that regulates movement of the valve body 114 in a radial direction. The orifice 116 and the guide portion 120 are integrally formed in FIG. 1, but may be separate members. The movement of the valve body 214 is restricted in the radial direction at two points with inner diameters of the guide portion 120 and the magnetic core 107 that comes in sliding contact with a brim portion 130 of the valve body 114, and the valve body is configured to operate in a valve opening direction and a valve closing direction (valve opening and closing directions).

When the mover 102 and the valve body 114 are fixed, the zero spring 112 is not required.

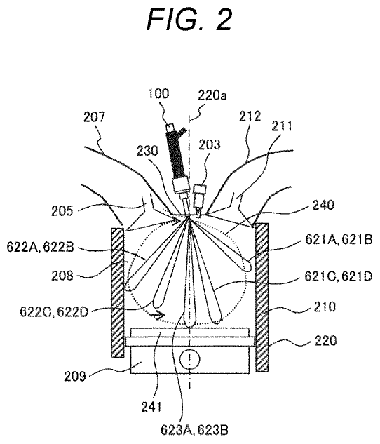

Next, the configuration of the present embodiment and the problems of the fuel injection device will be described with reference to FIGS. 2 to 7.

FIG. 2 is a schematic diagram of an in-cylinder direct injection type internal combustion engine (direct injection engine) in which the fuel is directly injected into a cylinder inside 208 and which is equipped with the fuel injection device 100 according to the embodiment of the present invention. FIG. 2 shows a state of fuel sprays on the engine cylinder inside 208 immediately after the fuel is injected from a distal end portion of the orifice 116 of the fuel injection device 100. The engine cylinder inside 208 may be simply referred to as the in-cylinder.

The direct injection engine in the present embodiment includes the fuel injection device 100, intake valves 205, an ignition plug 203, exhaust valves 211, an intake pipe 207, an exhaust pipe 212, a piston 209, and a cylinder 220 including the piston 209.

The fuel injection device 100 is attached to a position 230 directly above the cylinder 220, and two intake valve 205 and two exhaust valve 211 are attached to the left and right. In FIG. 2, for the sake of description, the description will be made with reference to the drawing in which the intake valve 205 and the exhaust valve 211 are attached to the same cross section as the fuel injection device 100. A left-right direction here is defined by a left-right direction on FIG. 2.

First, an operation of the direct injection engine will be described. After the intake valve 205 is opened, air (gas) passed through the intake pipe 207 is guided to the engine cylinder inside 208, and the fuel is injected from the fuel injection device 100 in accordance with a flow 240 of the inflowing air. The injected fuel follows the flow of the air guided to the engine cylinder inside 208, and is mixed with the air. Thus, an air-fuel mixture is formed. Thereafter, at a timing at which the piston 209 approaches a top dead center, the air-fuel mixture is burned by igniting the air-fuel mixture by the ignition plug 203, and a propulsive force is obtained.

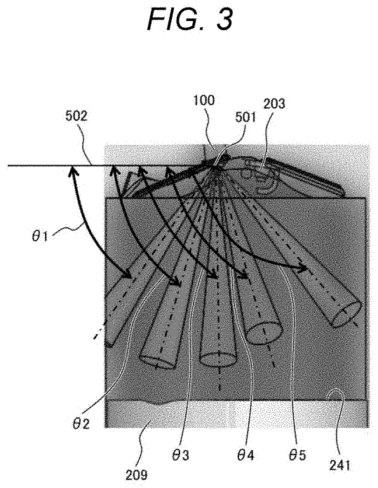

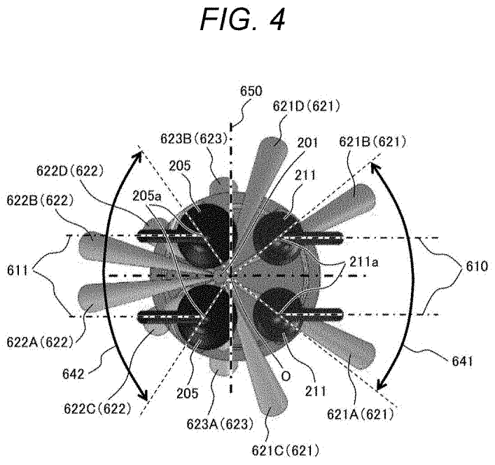

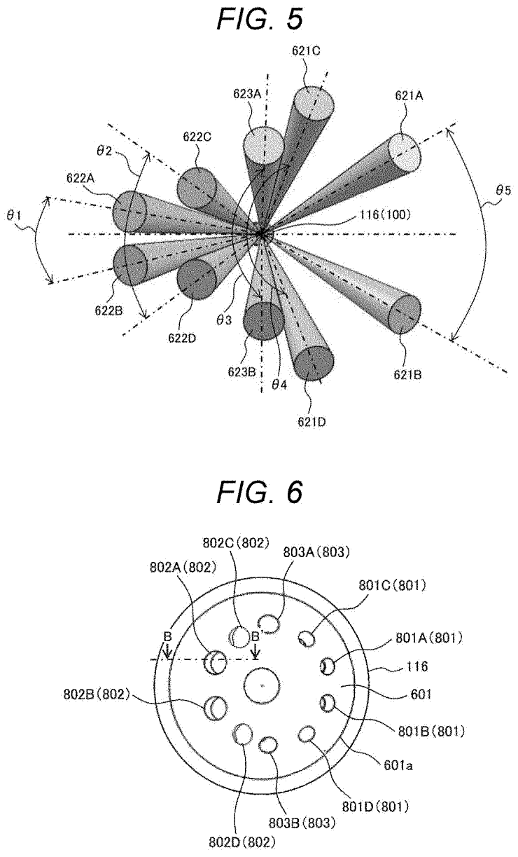

FIG. 3 is a schematic diagram showing a form of the fuel sprays injected into the cylinder inside (inside the cylinder 210) of FIG. 2. FIG. 4 is a projection view of the fuel sprays injected from the fuel injection device 100 when FIG. 3 is viewed in a direction of the piston 214 from the fuel injection device 100 side. FIG. 5 is a projection view of the fuel sprays injected from the fuel injection device 100 when FIG. 3 is viewed in a direction of the fuel injection device 100 from the piston 214 side.

In the following description, on FIG. 6, an intake side (intake valve side or intake valve opening surface side) and an exhaust side (exhaust valve side or exhaust valve opening surface side) are partitioned as follows. The intake side and the exhaust side are partitioned by a surface 650 which is parallel to a center axis 220a of the cylinder 220 or the cylinder 208, includes the center axis 220a, and is parallel to line segments passing through two intake valve opening surface centers 205a or line segments passing through two exhaust valve opening surface centers 211a. A side on which the intake valves 205 are present is the intake side and a side on which the exhaust valves 211 are present is the exhaust side. Although a case where there are the two intake valves 205 and the two exhaust valves 211 has been described in the above description, when the numbers of intake valves 205 and exhaust valves 211 are different, the intake side and the exhaust side may be partitioned symmetrically with respect to the surface 650.

The fuel sprays injected from the fuel injection device 100 include sprays 621A and 621B directed to the ignition plug 203 side on the exhaust side, sprays 621C and 621D directed to the piston 209 direction on the exhaust side, sprays 622C and 622D directed to the piston 209 direction on the intake side, and sprays 622A and 622B further directed to the intake valve 205 side than the sprays 622C and 622D on the intake side. The sprays 621A and 621B are further directed to the exhaust valve 211 side than the sprays 621C and 621D on the exhaust side. In the present embodiment, the fuel sprays injected from the fuel injection device 100 further have sprays 622A and 623B injected from the fuel injection device 100 in a direction substantially perpendicular to a crown surface 241 of the piston 209. The sprays 621A, 621B, 621C, and 621D constitute a first spray group 621, the sprays 622A, 622B, 622C, and 622D constitute a second spray group 622, and the sprays 623A and 623B constitute a third spray group 623.

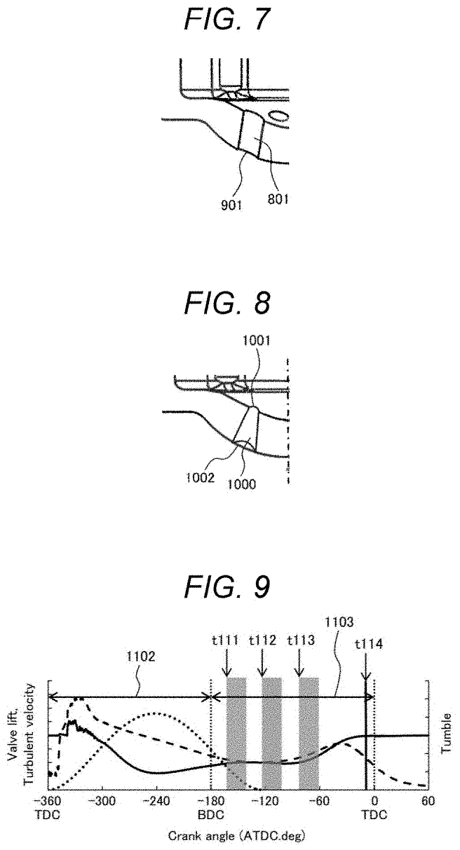

Next, a configuration of the orifice 116 of the fuel injection device 100 will be described with reference to FIGS. 6 and 7. FIG. 6 is an enlarged view of the orifice 116 viewed from a distal end direction of the fuel injection device 100 according to the first embodiment of the present invention. FIG. 7 is a sectional view of a cross section B-B′ in FIG. 6.

A seat surface 601 forming the valve seat 118 that seals the fuel has a substantially conical shape by coming in contact with the valve body 114, and seals the fuel by coming in contact with a spherical portion 114a (see FIG. 1) of the valve body 114. Thus, the seat surface 601 has a seat portion 601a coming in contact with the spherical portion 114a. The injection holes 119 (see FIG. 1) include an injection hole 801A forming the spray 621A, an injection hole 801B forming the spray 621B, an injection hole 801C forming the spray 621C, an injection hole 801D forming the spray 621D, an injection hole 802A forming the spray 622A, an injection hole 802B forming the spray 622B, an injection hole 802C forming the spray 622C, an injection hole 802D forming the spray 622D, an injection hole 803A forming the spray 623A, and an injection hole 803B forming the spray 623B.

In the present embodiment, as shown in FIG. 7, the injection holes 801A, 801B, 801C, 801D, 802A, 802B, 802C, 802D, 803A, and 803B are formed in a cylindrical shape having a uniform injection hole diameter from an inlet side to an outlet side.

Referring back to FIGS. 3, 4, and 5, the description will be made. FIG. 3 shows the state of the fuel sprays of the engine cylinder inside 208 immediately after the fuel is injected from the distal end portion of the orifice 116 of the fuel injection device 100.

The fuel sprays injected from the fuel injection device 100 have the first spray group 621 directed to the direction of the exhaust valve opening surface centers 211a which are intersections between center axes 610 of the exhaust valves 211 and end surfaces (or exhaust valve opening surfaces) of the exhaust valves 211 on a combustion chamber side with respect to the intake valve opening surface centers 205a which are intersections between center axes 611 of the intake valves 205 and the end surfaces (or intake valve opening surfaces) of the intake valves 205 on the combustion chamber side, and the second spray group 622 directed to the direction of the intake valve opening surface centers 205a with respect to the exhaust valve opening surface centers 211a. A flow rate of the second spray group 622 is higher than a flow rate of the first spray group 621.

Center axes of the sprays 621A, 621B, 621C, and 621D in the first spray group 621 are positioned on the exhaust valves 211 side of the combustion chamber center 650, and center axes of the spray 622A, 622B, 622C, and 622D in the second spray group 622 are positioned on the intake valves 205 side of the combustion chamber center 650. Alternatively, the first spray group 621 is injected such that the center axes (injection directions) of the sprays 621A, 621B, 621C, and 621D are directed to the exhaust valves 211 side of the combustion chamber center 650, and the second spray group 622 is injected such that the center axes (injection directions) of the sprays 622A, 622B, 622C, and 622D are directed to the intake valves 205 side of the combustion chamber center 650.

Although since center axes of the third spray group 623 are substantially on an interface 650 between the intake side and the exhaust side, the third spray group 623 is different from the first spray group 621 and the second spray group 622 in the present embodiment, the third spray group is included in the first spray group 621 when the center axes (injection directions) are directed to the exhaust side, and is included in the second spray group 622 when the center axes (injection directions) are directed to the intake side. Even in this case, a relationship between the flow rates of the first spray group 621 and the second spray group 622 satisfies the above-mentioned relationship.

The flow of the air flowing into the engine cylinder inside from the intake port 207 (hereinafter, referred to as a “flow”) forms a clockwise flow in the engine in-cylinder 208, as indicated by a reference sign 240 in FIG. 2. In this case, the following effects are obtained by disposing the fuel injection device 100 at the position 230 directly above the cylinder 220 and forming the fuel sprays as shown in FIG. 4.

A second injection hole group 802 injects the fuel in a direction against or in a region against the flow 240, and thus, the injected fuel sprays are pushed back to the flow 240. As a result, the fuel sprays injected from the second injection hole group 802 hardly adhere to a cylinder wall surface 210 and the crown surface 241 of the piston 209. On the other hand, the first injection hole group 801 injects the fuel in a direction along the flow 240, and thus, the injected fuel sprays follow the flow 240. Accordingly, penetration increases, and thus, the fuel sprays easily adhere to the cylinder wall surface 210 and the crown surface 241 of the piston 209. Accordingly, a flow rate of the second injection hole group 802 is higher than that of the first injection hole group 801, and thus, it is possible to suppress the adhesion of the fuel to the cylinder wall surface 210 and the piston crown surface 241. As a result, HC and PN can be reduced.

Thus, a total cross-sectional area of injection hole outlet surfaces of the second injection hole group 802 is larger than a total cross-sectional area of injection hole outlet surfaces of the first injection hole group 801. In other words, an inner diameter of an injection hole outlet of the second injection hole group 802 becomes larger than an inner diameter of an injection hole outlet of the first injection hole group 801.

The first injection hole group 801 includes the injection holes 801A, 801B, 801C, and 801D. The second injection hole group 802 includes the injection holes 802A, 802B, 802C, and 802D. The injection hole outlet surface corresponds to an injection hole outlet 901 in terms of the injection hole 801. The same applies to the other injection holes 802 and 803. Although the injection hole has an annular shape having a uniform diameter from an inlet to an outlet in the present embodiment, a cross-sectional area of the injection hole outlet surface is important, and the shape of the injection hole may not have the annular shape or may be an ellipse or the like. The same applies to the other injection holes 802 and 803.

When the total cross-sectional area of the injection hole outlets of the injection holes 802A, 802B, 802C, and 802D of the second injection hole group 802 is increased, since a penetration force of the sprays injected from the injection hole group 802 becomes stronger, even though a large amount of fuel is injected in the direction of the flow 240, since the fuel sprays easily diffuse into the cylinder inside 208, homogeneity of the air-fuel mixture can be improved. As a result, even though the fuel is injected into in a compression stroke, it becomes easy to create a homogeneous state of the air-fuel mixture, a rich equivalence ratio can be suppressed, and PN can be reduced.

When the shape of the injection holes 801, 802, or 803 is columnar (cylindrical), a cross-sectional area S of the injection hole 801, 802, or 803 is S=(π·r²)/4 by an inner diameter r of the injection hole outlet and a ratio of a circle's circumference to a diameter. According to the configuration of the present embodiment, the inner diameter of the injection hole outlet of the second injection hole group 802 may be larger than the inner diameter of the injection hole outlet of the first injection hole group 801. As a result, the total cross-sectional area of the injection holes of the second injection hole group 802 becomes larger than that of the first injection hole group 801, and an effect of reducing PN is enhanced.

As shown in FIGS. 5 and 6, although the second injection hole group 802 is constituted by the four injection holes 802A, 802B, 802C, and 802D and the second spray group 622 is constituted by the four sprays 622A, 622B, 622C, and 622D in the present embodiment, when the flow rate of the spray group 622 can be increased, the number of sprays and the number of injection holes may be less than four. In this case, the number of injection holes is decreased, and thus, a processing time can be reduced. Accordingly, cost of the fuel injection device 100 can be suppressed.

As shown in FIG. 3, the fuel injection device 100 may be configured such that as intersection angles θ1 to θ5 between the injection holes (sprays) and a horizontal line 502 which is pulled to the intake valves 205 side in a horizontal direction of a combustion chamber (cylinder inside) 208 from a center 501 of a distal end portion of the fuel injection device 100 become larger, the flow rate of the sprays become smaller. In the configuration of FIG. 3, the intersection angles become large in order from the intersection angles 503 to 507. In this case, the diameters of the injection holes may be decreased in the order of the injection holes 802A and 802B, the injection holes 802C and 802D, the injection holes 803A and 803B, the injection holes 801C and 801D, and the injection holes 801A and 801B.

As shown in FIG. 2, the flow 240 goes around from the exhaust side to the intake side, and then flows in the vicinity of the intake valves 205 in parallel with the horizontal line 502 of the combustion chamber 208. Accordingly, as the intersection angles between the horizontal line 502 and the sprays become smaller, the flow 240 and the sprays face each other. Thus, as the intersection angles between the horizontal line 502 and the sprays may become smaller, the flow rate may become larger. In other words, as the intersection angles between the horizontal line 502 and the injection holes may become larger, the flow rate of the sprays may become smaller. Even though the flow rate is increased, since the sprays are pushed back to the flow 240, the sprays hardly adhere to the piston crown surface 241 and the cylinder wall surface 210, and thus, PN can be suppressed.

Although the flow 240 describes a tumble formed clockwise in the present embodiment. For example, when one side of the intake port is closed, even in a case of a swirl flow in which a flow of a swirl that swirls in a circumferential direction of the combustion chamber 208 is formed, it is possible to suppress the adhesion of the fuel sprays to the cylinder wall surface 210 and the piston crown surface 214 by increasing the flow rate of the sprays facing the flow and decreasing the flow rate of the sprays along the flow.

Next, angles of the sprays will be described with reference to FIGS. 3 and 5. Here, it is assumed that an included angle formed by a spray pair constituted by the sprays 622A and 622B is Δθ1, an included angle formed by a spray pair constituted by the sprays 622C and 622D is Δθ2, an included angle formed by a spray pair constituted by the sprays 623A and 623B is Δθ3, an included angle formed by a spray pair constituted by the sprays 621C and 621D is Δθ4, and an included angle formed by a spray pair constituted by the sprays 621A and 621B is Δθ5. The included angle is an angle formed between spray center axes of the sprays forming the spray pair.

The spray center axis is an axis that passes through a center of a spray cross section and is directed to an injection direction of the fuel injected from the injection hole. Since the injection direction of the fuel injected from the injection hole is set by a center axis (penetration direction) of the injection hole, the spray center axis may be considered to coincide with the center axis of the injection hole.

The included angle Δθ1 between the center axes of the two sprays 622A and 622B formed by the two injection holes 802A and 802B that are part of the second injection hole group 802 may be smaller than the included angle Δθ5 between the spray center axes formed by the two sprays 621A and 621B injected from the two injection holes 801A and 801B which are part of the first injection hole group 801.

The included angles Δθ1 and Δθ2 are decreased such that the spray 622 of the second injection hole group 802 faces the flow 240, and thus, a relative velocity between the sprays 622A and 622B and the flow 240 can be increased. The sprays are atomized, and thus, it is possible to suppress the adhesion of the fuel to the piston crown surface 214 and the cylinder wall surface 210. In the present embodiment, the included angle Δθ1 is the smallest by being set to be smaller than the included angle Δθ2. Since the spray 621 of the first injection hole group 801 is injected in the direction along the flow 240, the included angles Δθ4 and Δθ5 are set to be larger than the included angles Δθ1 and Δθ2. In this case, the included angle Δθ5 is set to be smaller than the included angle Δθ4. The included angles Δθ4 and Δθ5 are set to be larger than the included angles Δθ1 and Δθ2, and thus, an effect of extending the penetration with the flow 240 can be suppressed, and the fuel adhesion to the piston crown surface 214 or the cylinder wall surface 210 can be suppressed. According to the effects of the present embodiment, the fuel adhesion is suppressed, and thus, HC and PN can be reduced.

In this case, the included angles between the spray center axes of the sprays other than the spray pair of 621A and 621B may become larger in order from the spray pairs closer to the exhaust side.

As shown in FIG. 3, it is assumed that the intersection angle of the spray formed by the horizontal line 502 and the spray center axis of the spray 622A or 622B is θ1, the intersection angle of the spray formed by the horizontal line 502 and the spray center axis of the spray 622C or 622D is 02, the intersection angle of the spray formed by the horizontal line 502 and the spray center axis of the spray 623A or 623B is 03, the intersection angle of the spray formed by the horizontal line 502 and the spray center axis of the spray 621C or 621D is 04, and the intersection angle of the spray formed by the horizontal line 502 and the spray 621A or 621B is 05.

As the intersection angles may become larger, the included angles (angles) of the spray center axes of the sprays other than the spray pair of 621A and 621B may become larger. In the case of the present embodiment, the included angles become large in order of Δθ1, Δθ2, Δθ3, and Δθ4. That is, Δθ1, Δθ2, Δθ3, and Δθ4 have a relationship of Δθ1<Δθ2<Δθ3<Δθ4.

As the intersection angles of the sprays with respect to the water line 502 become larger, the included angles of the sprays become larger. Thus, the flow rate of the sprays along the flow 240 can be suppressed, and the effect of extending the penetration can be suppressed.

As a result, PN can be reduced.

The spray pair of 621A and 621B directed in the ignition plug 203 direction is injected, as the fuel, in the vicinity of the ignition plug 203 in order to improve ignitability. Thus, it is necessary to reduce the included angle Δθ5 to some extent. When the fuel directly hits the ignition plug 203, since fog may occur and combustion stability may deteriorate, it is necessary to secure the angle of a certain level or more. Accordingly, it is possible to achieve both combustion stability and adhesion reduction by setting the included angle Δθ5 to be smaller than the included angle Δθ4 and further setting the included angle Δθ5 to be larger than the included angle Δθ1.

FIG. 8 is a diagram showing a change example in which the shape of the injection hole of the fuel injection device 100 according to the first embodiment of the present invention is changed.

For example, when an injection hole 1000 has a shape in which a cross-sectional area changes from an inlet surface 1001 to an outlet surface 1002 as shown in FIG. 8, the flow rate is decided by the inlet surface 1001 of which a cross-sectional area in a radial direction is minimized with respect to a center axis of the injection hole 1000. In such a case, the cross-sectional areas having the minimum cross-sectional areas may be compared, and the cross-sectional areas of the injection holes may be set.

The fuel injection device 100 may be configured such that the sprays 622C and 622D included in the second spray group 622 are the sprays included in the first injection hole group 621. Hereinafter, a case where the sprays 622C and 622D are included in the first injection hole group 621 will be described.

The flow rate of the injection holes 802C and 802D of the spray 622C and 622D is smaller than that of the injection holes 802A and 802B of the second spray group 622. The angles between an orientation of the flow 240 and the sprays 622C and 622D are smaller than the angles between the orientation of the flow and the injection holes 802A and 802B of the second spray group 622. Thus, the flow rate of the injection holes 802C and 802D is set to be smaller than that of the injection holes 802A and 802B, and thus, it is possible to suppress the adhesion of the fuel to the piston crown surface 241 and the cylinder 210.

The total cross-sectional area of the injection hole outlets of the injection holes 802C and 802D of the spray 622C and 622D may be smaller than that of the injection holes 802A and 802B of the second spray group 622. When the total cross-sectional area of the injection hole outlets of the injection holes 802C and 802D is decreased, since the penetration force of the sprays 622C and 622D is weaker than that of the sprays 622A and 622B injected from the injection holes 802A and 802B, even though the fuel is injected in a direction further deviating from the flow 240 than the injection holes 802A and 802B, the fuel adhesion to the cylinder 210 can be suppressed, and PN can be reduced.

The included angle Δθ2 between the spray center axes of the sprays 622C and 622D may be larger than the included angle Δθ1 between the spray center axes of the second spray group 622 (622A and 622B).

Since the intersection angle θ2 formed by the center axes of the sprays 622C and 622D and the flow 240, that is, the horizontal line 502 of the combustion chamber 208 is smaller than in the case of the sprays formed by the injection holes 802A and 802B of the second injection hole group 622, the included angle Δθ2 is set to be larger than the included angle Δθ1 of the sprays formed by the injection holes 802A and 802B of the second injection hole group 622, and thus, a distance from the cylinder wall surface 210 or the piston crown surface 214 is secured, and the fuel adhesion can be suppressed. As a result, HC and PN can be reduced.

The center axes of the sprays and the center axes of the injection holes have a substantially the same straight relationship. For example, the center axes of the sprays 622A and 622B forming the second injection hole group 622 and the center axes of the injection holes 802A and 802B are substantially the same straight line.

Next, one row of injection control of the fuel injection device 100 at the start of a cold air will be described with reference to FIG. 9. FIG. 9 is a diagram showing an injection method executed by the control device 154 according to the first embodiment of the present invention. FIG. 9 shows an injection timing and an injection period in the first embodiment.

In FIG. 9, a crankshaft angle is represented on a horizontal axis. TDC of an intake stroke corresponds to −360 deg, BDC corresponds to −180 deg, and TDC of a compression stroke corresponds to 0 deg. A lift amount of the intake valve 205 is indicated by a dotted line, an average value of a turbulent velocity of the engine cylinder inside is indicated by a broken line, and a size of a tumble of the cylinder inside is indicated by a solid line.

At the start of the cold air, since a temperature of the cylinder wall surface 210 and the piston crown surface 241 of the cylinder inside is low, the injected air-fuel mixture easily adheres, and PN is easily generated.

In order to suppress the fuel adhesion, it is effective to inject the fuel into compression stroke 1103 which has a high cylinder inside pressure. In order to suppress the adhesion to the piston crown surface 241, the fuel may be injected near BDC where a distance between the fuel injection device 100 and the piston crown surface 241 is long. When the fuel is injected in the vicinity of the BDC, since the distance between the fuel injection device 100 and the piston crown surface 241 can be increased, the injected fuel hardly adheres to the piston crown surface 241.

According to the present embodiment, the fuel may be injected at timing till, timing t112, and timing t113 of compression stroke 703.

In compression stroke 1103 in which the piston 209 is moving toward a top dead center, since a cylinder inside pressure is higher than in the case of the injection in intake stroke 1102, the injected sprays are pushed back, and the fuel hardly adheres to the piston crown surface 241 and the in-cylinder wall surface 210. On the other hand, when the fuel is injected in the compression stroke, since the tumble in the cylinder inside is smaller than in the case of the injection in intake stroke 1102, the injected fuel and the air are hardly mixed, and a fuel-rich air-fuel mixture is easily formed. The fuel-rich air-fuel mixture is, for example, an equivalence ratio of 1.5 or more.

The total cross-sectional area of the injection hole outlet surfaces of the second injection hole group 802 is set to be larger than the total cross-sectional area of the injection hole outlet surfaces of the first injection hole group 801, and thus, the flow rate of the sprays facing the flow 240 becomes large. Accordingly, a relative velocity between the air and the fuel becomes high, and thus, the fuel becomes atomized and easily diffuses into the cylinder inside. As a result, even though the fuel is injected in compression stroke 1103, the fuel and the air are easily mixed, and the rich air-fuel mixture can be suppressed. In particular, although an example in which the fuel is injected three times in the compression stroke has been described in FIG. 9, when more fuel is injected in the compression stroke than in the intake stroke, the effects of the present invention are enhanced.

According to the present embodiment, an effect of reducing PN is enhanced by achieving both the reduction of the fuel adhesion and the reduction of the rich equivalence ratio.

It is preferable that the fuel is injected such that the second spray group 622 is directed to an intake valve inside 642 between the two intake valve opening surface centers 205a with respect to an exhaust valve inside 641 between the two exhaust valve opening surface centers 211a and the first spray group 621 is directed to an exhaust valve inside 641 with respect to the intake valve inside 642. In other words, it is preferable that the fuel is injected such that the second injection hole group 802 is directed to the inside of the two intake valve opening surface centers 205a with respect to the inside of the two exhaust valve opening surface centers 211a and the first injection hole group 801 is directed to the inside of the two exhaust valve opening surface centers 211a with respect to the inside of the two intake valve opening surface centers 205a. Accordingly, an effect of suppressing the fuel from adhering to the piston crown surface 214 and the cylinder wall surface 210 is improved.

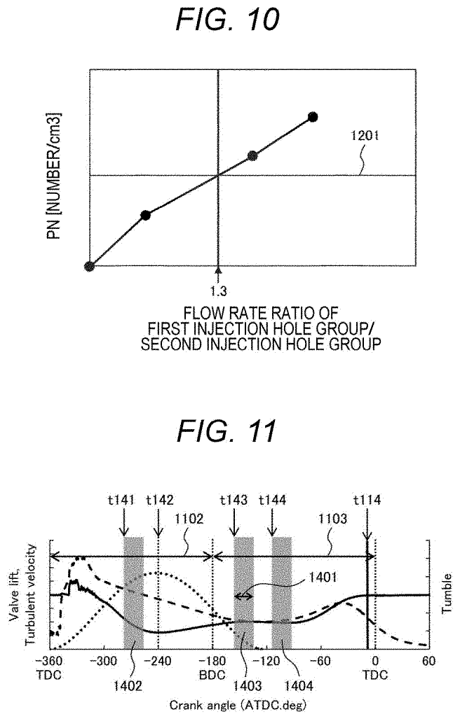

A flow rate ratio between the first injection hole group 801 and the second injection hole group 802 will be described with reference to FIG. 10. FIG. 10 is a diagram showing a relationship between the flow rate ratio of the first injection hole group 801 and the second injection hole group 802 and PN according to the embodiment of the present invention. In FIG. 10, PN is the number of pieces of soot per unit volume, and 1201 is a target value of the PN. In a second embodiment, a configuration of the combustion injection device 100 is the same as that of the first embodiment.

The fuel injection device 100 having the plurality of injection holes in the second embodiment includes the first injection hole group 801 directed in the direction of the exhaust valve opening surface centers 211a with respect to the intake valve opening surface centers 205a and the second injection hole group 802 directed in the direction of the intake valve opening surface centers 205a with respect to the exhaust valve opening surface centers 211a, and the total cross-sectional area of the injection hole outlet surfaces of the second injection hole group 802 is more than 1.3 times larger than the total cross-sectional area of the injection hole outlet surfaces of the first injection hole group 801.

As the flow rate ratio between the first injection hole group 801 and the second injection hole group 802 which is obtained by dividing the flow rate of the first injection hole group 801 by the flow rate of the second injection hole group 802 becomes smaller, the PN discharged from the engine cylinder inside becomes smaller. According to the study, the flow rate ratio between the first injection hole group 801 and the second injection hole group 802 may be set to 1.3 or less in order to achieve the PN target value for starting the cold air.

When the flow rate of the second injection hole group 802 is large and the flow rate of the first injection hole group 801 is small, the flow rate of the sprays facing the flow 240 is increased, and the sprays of the second injection hole group 802 are pushed back by the flow 240. Accordingly, the adhesion of the fuel to the cylinder wall surface 210 and the piston crown surface 241 can be suppressed, and the PN can be reduced.

### Second Embodiment

The second embodiment according to the present invention will be described with reference to FIG. 11. FIG. 11 is a diagram showing an injection method executed by a control device 154 according to the second embodiment of the present invention. FIG. 11 shows an injection timing and an injection period in the third embodiment.

In FIG. 11, a crankshaft angle is represented on a horizontal axis. TDC of an intake stroke corresponds to −360 deg, BDC corresponds to −180 deg, and TDC of a compression stroke corresponds to 0 deg. A lift amount of the intake valve 205 is indicated by a dotted line, an average value of a turbulent velocity of the engine cylinder inside is indicated by a broken line, and a size of a tumble of the cylinder inside is indicated by a solid line.

In the control device 154 that controls the fuel injection device 100 of the present embodiment, the fuel injection device 100 may be controlled such that the fuel is injected at a timing from a time of the start of a lift of the intake valve 205 to a time of a maximum lift amount and a timing after a bottom dead center of BDC.

A range up to timing t142 at which the lift of the intake valve 205 of an intake stroke 1102 is maximized, for example, at timing t141, the fuel under may be injected under a condition that the tumble of the cylinder inside is strong. At this timing, since the flow against the spray is strong, the second spray group 621 of the second injection hole group 801 is pushed back to the flow 240, and the fuel hardly adheres to the cylinder wall surface 210 and the piston crown surface 214. Subsequently, although the flow, that is, the tumble is weak in BDC, since the distance between the fuel injection device 100 and the piston crown surface 214 is long, the sprays hardly adhere to the piston crown surface 214. Accordingly, the fuel may be injected at timing t143 near BDC. That is, the fuel injection device 100 may be controlled such that the fuel is injected at the timing from a time of the start of the lift of the intake valve 205 to a time of the maximum lift amount and the timing after the bottom dead center. Since there is period 1401 from timing t143 at which the fuel is injected to the end of the injection, when the injection period covers BDC, an effect of suppressing the fuel adhesion is obtained.

Third injection 1404 may be performed at injection timing t144 of compression stroke 1103. In the compression stroke, since the piston 209 moves upward and the cylinder inside pressure increases, even though the fuel is injected, the fuel hardly adheres to the cylinder wall surface 210 or the piston crown surface 214. When a large amount of fuel is injected in compression stroke 1103, since the flow 240 is weak, a mixing time of the sprays is short, and improvement of homogeneity may be a problem. In such a case, a flow rate in injection 1402 of intake stroke 1102 is set to be larger than a flow rate in injection 1404 of compression stroke 1103, and thus, it is possible to achieve both the improvement of the homogeneity and the suppression of the adhesion. For the above reason, the flow rate in injection 1404 of which the injection timing is later than that in injection 1403 is set to be small, effects of improving the homogeneity and suppressing the adhesion are enhanced.

### OTHER EXAMPLES

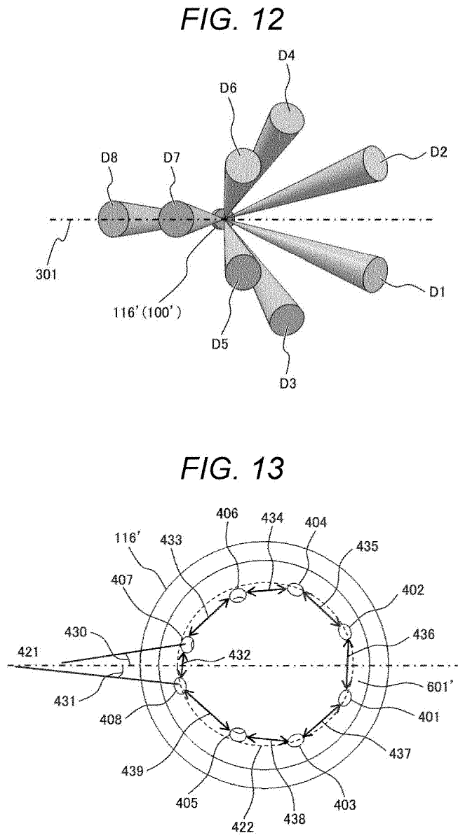

FIG. 12 is a projection view of fuel sprays injected from a fuel injection device 100′ when viewed in the direction of the fuel injection device 100 from the piston 209 side in FIG. 2, in another example of the fuel injection device 100 (fuel injection device 100′). FIG. 13 is an enlarged view of an orifice 116′ viewed from a distal end direction of the fuel injection device 100′ of FIG. 12.

The fuel sprays injected from the fuel injection device 100′ include sprays D1 and D2 directed to the exhaust side, that is, the ignition plug 203 side, D3 and D4 directed to the exhaust side, sprays D5 and D6 directed to the piston direction on the exhaust side, and sprays D7 and D8 directed to the intake side.

Next, a configuration of the orifice 116′ of the fuel injection device 100′ will be described with reference to FIG. 13. A seat surface 601′ forming the valve seat 118 (see FIG. 1) that seals the fuel has a substantially conical shape by coming in contact with the valve body 114 (see FIG. 1), and seals the fuel by coming in contact with the spherical portion 114a (see FIG. 1) of the valve body 114. The injection holes include an injection hole 401 forming the spray D1, an injection hole 402 forming the spray D2, an injection hole 403 forming the spray D3, an injection hole 404 forming the spray D4, an injection hole 405 forming the spray D5, an injection hole 406 forming the spray D6, an injection hole 407 forming the spray D7, and an injection hole 408 forming the spray D8.

The injection hole 407 and the injection hole 408 forming the sprays D7 and D8 arranged in the same straight line 301 are arranged in the vicinity substantially on the same circumference 422, and the sprays are performed on the same straight line 301 from the position of the circumference 422. As a result, the spray D7 of the injection hole 407 has an angle of 430, and the spray D8 of the injection hole 408 has an angle 431. A distance 432 between the injection hole 407 and the injection hole 408 is set to be smaller than a distance 433, a distance 434, a distance 435, a distance 436, a distance 437, a distance 438, and a distance 439 between the other injection holes, and thus, the penetration force is strengthened by aligning directions of velocity vectors of the spray D7 and the spray D8 injected from the injection hole 407 and the injection hole 408. Accordingly, a relative velocity between the spray D7 and the spray D8 and the flow 240 facing the spray D8 is secured, and an effect of enhancing the atomization effect and an effect of improving the homogeneity can be obtained.

The injection hole 407 of the spray D7 is disposed on the exhaust side of the spray D8 may be disposed inside on the circumference 422 than the injection hole 408 of the spray D8 closest to the intake side. Due to this effect, since the injection hole 408 is positioned on an upstream side, the fuel easily flows, the penetration force of the spray D8 facing the tumble is strengthened, and an atomization effect is enhanced.

According to each of the above-described embodiments, the following fuel injection device 100 or the control device 154 thereof are obtained.

(1) In a fuel injection device 100 having a plurality of injection holes, the fuel injection device includes a first injection hole group 801 that is directed in a direction on an exhaust valve 211 side with respect to an intake valve 205 side, and a second injection hole group 802 that is directed in a direction on the intake valve 205 side with respect to the exhaust valve 211 side. A flow rate of the second injection hole group 802 is larger than a flow rate of the first injection hole group 801.

(2) In a fuel injection device 100 having a plurality of injection holes, the fuel injection device includes a first injection hole group 801 that is directed in a direction on an exhaust valve 211 side with respect to an intake valve 205 side, and a second injection hole group 802 that is directed in a direction on the intake valve 205 side with respect to the exhaust valve 211 side. A total cross-sectional area of injection hole outlet surfaces of the second injection hole group 802 is larger than a total cross-sectional area of injection hole outlet surfaces of the first injection hole group 801.

(3) In a fuel injection device 100 having a plurality of injection holes, a total cross-sectional area of injection holes that inject fuel in a direction along a flow direction of gas directed to an opening surface side of an exhaust valve 211 from an opening surface side of an intake valve 205 is smaller than a total cross-sectional area of injection holes that inject fuel in a direction facing the flow direction.

(4) In (1), a total cross-sectional area of injection hole outlet surfaces of the second injection hole group 802 is larger than a total cross-sectional area of injection hole outlet surfaces of the first injection hole group 801.

(5) In (2), the total cross-sectional area of the injection hole outlet surfaces of the second injection hole group 802 is more than 1.3 times larger than the total cross-sectional area of the injection hole outlet surfaces of the first injection hole group 801.

(6) In (3), as intersection angles between the injection holes and a horizontal line 502 pulled to a side of an intake valve 205 in a horizontal direction of a combustion chamber 208 from a distal end portion of the fuel injection device 100 become larger, a flow rate of sprays becomes smaller.

(7) In (2), the second injection hole group 802 is directed to an inside 642 of two intake valve opening surface centers 205a with respect to an inside 641 of two exhaust valve opening surface centers 211a, and the first injection hole group 801 is directed to the inside 641 of the two exhaust valve opening surface centers 211a with respect to the inside 642 of the two intake valve opening surface centers 205a.

(8) In (1), an inner diameter of an injection hole outlet of the second injection hole group 802 is larger than an inner diameter of an injection hole outlet of the first injection hole group 801.

(9) In (1), the first injection hole group 801 has a first injection hole pair of 801A and 801B that injects a first spray pair of 621A and 621B, the second injection hole group 802 has a second injection hole pair of 802A and 802B that injects a second spray pair of 622A and 622B, and an included angle Δθ5 formed by spray center axes of the first spray pair of 801A and 801B is larger than an included angle Δθ1 formed by spray center axes of the second spray pair of 622A and 622B.

(10) In (9), the first injection hole group 801 has a third injection hole pair of 801C and 801D that injects a third spray pair of 621C and 621D further directed to the intake valve 205 side than the first spray pair of 621A and 621B on the exhaust valve 211 side, the second injection hole group 802 has a fourth injection hole pair of 802C and 802D that injects a fourth spray pair of 622C and 622D further directed to the exhaust valve 211 side from the second spray pair of 802A and 802B on the intake valve 205 side, and an included angle Δθ4 formed by spray center axes of the third spray pair of 621C and 621D is large than an included angle Δθ1 formed by spray center axes of the second spray pair of 622A and 622B.

(11) In (10), the included angles formed by the spray center axes of the spray pairs other than the first spray pair of 621A and 621B become larger in order from the spray pairs closer to the exhaust valve 211 side.

(12) In (7), the fuel injection device 100 is attached to a position 230 directly above a cylinder 220.

(13) In a control device 154 that controls the fuel injection device 100, the fuel injection device 100 is controlled such that fuel is injected at a timing from a time of a start of a lift of an intake valve 205 to a time of a maximum lift amount and a timing after a bottom dead center.

The present invention is not limited to the aforementioned embodiments, and includes various modification examples. For example, the aforementioned embodiments are described in detail in order to facilitate easy understanding of the present invention, and are not limited to necessarily include all the components. Some of the components of a certain embodiment can be substituted into the components of another embodiment, and the components of another embodiment can be added to the component of a certain embodiment. In addition, the components of another embodiment can be added, removed, and substituted to, from, and into some of the components of the aforementioned embodiments.

### REFERENCE SIGNS LIST

100 fuel injection device
154 control device
205 intake valve
205a intake valve opening surface center
208 combustion chamber
211 exhaust valve
211a exhaust valve opening surface center
220 cylinder
230 directly above cylinder 220
502 horizontal line
621A,621B first spray pair
621C,621D third spray pair
622A,622B second spray pair
622C,622D fourth spray pair
641 inside of two exhaust valve opening surface centers 211a
642 inside of two intake valve opening surface centers 205a
801 first injection hole group
801A,801B first injection hole pair
801C,801 third injection hole pair
802 second injection hole group
802A,802B second injection hole pair,
802C,802D fourth injection hole pair
Δθ1 included angle formed by spray center axes of second spray pair of 622A and 622B
Δθ4 included angle formed by spray center axes of third spray pair of 621C and 621D
Δθ5 included angle formed by spray center axes of first spray pair of 801A and 801B

1. A fuel injection device having a plurality of injection holes, the fuel injection device comprising:
a first injection hole group that is directed in a direction on an exhaust valve side with respect to an intake valve side; and
a second injection hole group that is directed in a direction on the intake valve side with respect to the exhaust valve side,
wherein a flow rate of the second injection hole group is larger than a flow rate of the first injection hole group.

2. A fuel injection device having a plurality of injection holes, the fuel injection device comprising:
a first injection hole group that is directed in a direction on an exhaust valve side with respect to an intake valve side; and
a second injection hole group that is directed in a direction on the intake valve side with respect to the exhaust valve side,
wherein a total cross-sectional area of injection hole outlet surfaces of the second injection hole group is larger than a total cross-sectional area of injection hole outlet surfaces of the first injection hole group.

3. A fuel injection device having a plurality of injection holes, in which a total cross-sectional area of injection holes that inject fuel in a direction along a flow direction of gas directed to an exhaust valve opening surface side from an intake valve opening surface side is smaller than a total cross-sectional area of injection holes that inject fuel in a direction facing the flow direction.

4. The fuel injection device according to claim 1,
wherein a total cross-sectional area of injection hole outlet surfaces of the second injection hole group is larger than a total cross-sectional area of injection hole outlet surfaces of the first injection hole group.

5. The fuel injection device according to claim 2,
wherein the total cross-sectional area of the injection hole outlet surfaces of the second injection hole group is more than 1.3 times larger than the total cross-sectional area of the injection hole outlet surfaces of the first injection hole group.

6. The fuel injection device according to claim 3,
wherein as intersection angles between the injection holes and a horizontal line pulled to a side of an intake valve in a horizontal direction of a combustion chamber from a distal end portion of the fuel injection device become larger, a flow rate of sprays becomes smaller.

7. The fuel injection device according to claim 2,
wherein the second injection hole group is directed to an inside of two intake valve opening surface centers with respect to an inside of two exhaust valve opening surface centers, and
the first injection hole group is directed to the inside of the two exhaust valve opening surface centers with respect to the inside of the two intake valve opening surface centers.

8. The fuel injection device according to claim 1,
wherein an inner diameter of an injection hole outlet of the second injection hole group is larger than an inner diameter of an injection hole outlet of the first injection hole group.

9. The fuel injection device according to claim 1,
wherein the first injection hole group has a first injection hole pair that injects a first spray pair,
the second injection hole group has a second injection hole pair that injects a second spray pair, and
an included angle formed by spray center axes of the first spray pair is larger than an included angle formed by spray center axes of the second spray pair.

10. The fuel injection device according to claim 9,
wherein the first injection hole group has a third injection hole pair that injects a third spray pair further directed to the intake valve side than the first spray pair on the exhaust valve side,
the second injection hole group has a fourth injection hole pair that injects a fourth spray pair further directed to the exhaust valve side from the second spray pair on the intake valve side, and
an included angle formed by spray center axes of the third spray pair is large than an included angle formed by spray center axes of the second spray pair.

11. The fuel injection device according to claim 10,
wherein the included angles formed by the spray center axes of the spray pairs other than the first spray pair become larger in order from the spray pairs closer to the exhaust valve side.

12. The fuel injection device according to claim 7,
wherein the fuel injection device is attached directly above a cylinder.

13. A control device that controls the fuel injection device according to claim 1, in which the fuel injection device is controlled such that fuel is injected at a timing from a time of a start of a lift of an intake valve to a time of a maximum lift amount and a timing after a bottom dead center.
